(19) United States
(12) Patent Application Publication
(10) Pub. No.: US 2013/0187790 A1
(43) Pub. Date: Jul. 25, 2013

(54) MEASUREMENT TRANSMITTER HAVING A PLURALITY OF FIELDBUS ADDRESSES AND METHOD FOR RETRIEVING MEASURED VALUES FROM SUCH A MEASUREMENT TRANSMITTER

(71) Applicants: Michael Konrad, Pfronten (DE); Stephan Konrad, Rieden (DE); Michael Korn, Marktoberdorf (DE)

(72) Inventors: Michael Konrad, Pfronten (DE); Stephan Konrad, Rieden (DE); Michael Korn, Marktoberdorf (DE)

(21) Appl. No.: 13/876,917

(22) PCT Filed: Aug. 25, 2011
(86) PCT No.: PCT/EP2011/064653

§ 371 Date: Mar. 29, 2013

(30) Foreign Application Priority Data
Oct. 1, 2010 (DE) 10 2010 041 866.8

(51) Int. Cl. G08C 19/00

(52) U.S. Cl. CPC G08C 19/00
USPC 340/870.3

(57) ABSTRACT

A measurement transmitter having an interface for transmission of measured values via a fieldbus, wherein communication via the fieldbus occurs according to a fieldbus protocol, wherein the number of measured values provided by the measurement transmitter exceeds the number of measured values retrievable by means of a basic command of the fieldbus protocol, wherein the measurement transmitter has a plurality of fieldbus addresses, and wherein a logic unit is provided, which serves so to distribute the measured values among the plurality of fieldbus addresses of the measurement transmitter that the measured values are retrievable via the plurality of fieldbus addresses of the measurement transmitter by means of the basic command.

The invention relates to a measurement transmitter having an interface for transmission of measured values via a fieldbus, wherein communication via the fieldbus occurs according to a fieldbus protocol, wherein the number of measured values provided by the measurement transmitter exceeds the number of measured values retrievable by means of a basic command of the fieldbus protocol.

Furthermore, the invention relates to a method for retrieving measured values, wherein the measured values are provided by a measurement transmitter, which is connected to a fieldbus and has a plurality of fieldbus addresses, wherein communication via the fieldbus occurs according to a fieldbus protocol, and wherein the number of measured values provided by the measurement transmitter exceeds the number of measured values retrievable by means of a basic command of the fieldbus protocol.

In plants of process automation technology, field devices are often applied, which control the processes running in the plants through the application of open and/or closed loop control. Such field devices are composed, for example, of a measurement transmitter, to which is connected at least one measuring transducer, which serves for registering a chemical and/or physical, measured variable. Additionally, these field devices, more exactly the measurement transmitters, are currently often connected with one another via a fieldbus. In this way, the measurement transmitters can exchange information with one another and/or with a control unit, which controls the process. Thus, the information can include, for example, data concerning measured values. Known from the state of the art for data transmission via the fieldbus are various so-called fieldbus protocols.

In the case of the HART protocol, for example, there are different groups of commands. The universal commands, also named the basic commands, permit, for example, the identification of a HART-device connected to the fieldbus. Thus, for example, manufacturer, measuring point identification, serial number, etc. can be read out. Moreover, likewise by means these basic commands, up to four measured values, including their physical units of measure, can be read digitally from a measurement transmitter. The basic commands are supported by all HART slave devices. General commands (common practice commands) serve, in turn, for basic adjusting of HART devices. In this way, for example, very simple field devices can be controlled and serviced. In contrast, for start-up of more complex field devices, device-specific commands must be used. These are specified by the manufacturer of the devices and, consequently, are also called manufacturer-specific commands. A master connected to a fieldbus must know these commands and thus be correspondingly programmed. In such case, attention must be paid that a given command is uniquely defined and does not trigger different functions, for example, in the case of different devices, especially measurement transmitters, connected to the fieldbus.

Somewhat the same holds also for the Profibus protocol, in the case of which there are, likewise, basic commands, which enable the identification, etc., of the device, especially a measurement transmitter, connected to the fieldbus. With Profibus, there are, depending on applied application-profile, different functions available, such as, for example, parameter- and/or measured value querying. In such case, there are, for example, in the PROFIdrive-profile, about 30 parameter queries specified in the standard, while the remaining measured values, or parameters (in the case of complex devices, there can be over 1000) are retrieved using manufacturer-specific commands.

Known from the state of the art in the form of Offenlegungsschrift DE 102007039529 A1 is a method for servicing a field device having at least two measuring channels. The field device there includes a number of communication controllers, which have different fieldbus addresses. In this way, the field device appears on the fieldbus as a number of logically independent field devices and each of the logically independent field devices can be serviced by means of a separate device description. If, now, one of the communication controllers determines that an address contained in a fieldbus telegram agrees with its own fieldbus address, then this communication controller sends wanted data in the form of a response telegrams via the fieldbus.

Also in the case of the device proposed in DE 102007039529 A1, there is, furthermore, the problem that in the situation, in which a field device provides, for example, more measured values than are retrievable by means a (single) basic command, these measured values can be downloaded only via a general command (common practice command), or a manufacturer-specific command (device specific command). These commands must then be introduced and defined for this specific purpose. In this way, however, it can happen that devices connected to a fieldbus become no longer compatible with all HART master devices. Thus, for example, the case can arise in which the same manufacturer-specific commands are utilized in different plants for invoking different functions.

An object of the invention is to enable the retrieving of all measured values provided by a measurement transmitter by means of a command available to all field devices compatible with a given fieldbus protocol.

The object is achieved according to the invention by a measurement transmitter and by a method.

As regards the measurement transmitter, the object is achieved by features including that the measurement transmitter has a plurality of fieldbus addresses, and that a logic unit is provided, which serves so to distribute the measured values among the plurality of fieldbus addresses of the measurement transmitter that the measured values are retrievable via the plurality of fieldbus addresses of the measurement transmitter by means of the basic command.

The interface of the measurement transmitter can be a communication interface, especially one with only one communication controller. The communication controller serves to (pre-)process, or to condition data coming from the fieldbus and received via the (communication-)interface. The interface can be, for example, a wired interface, which serves for communication, i.e. for sending and/or receiving data, for example, in the form of telegrams via the fieldbus. The fieldbus is preferably a wired fieldbus. The protocol can be, for example, the HART protocol or the Profibus protocol. It is, however, also possible to use other protocols, especially fieldbus protocols. These protocols have so-called basic commands, which all devices compatible with the protocol use. In this way, it can be assured that all measured values, which a field device, or the measurement transmitter, makes available, can be downloaded. Especially, when the measurement transmitter provides more measured values than can be queried by means of a (single) basic command, it can be provided that the measured values are so distributed among the plurality of fieldbus addresses that at least one part of the measured values is retrievable by means of the basic command from, in each case, one of the fieldbus addresses of the measurement transmitter. In such case, for example, always the same basic command can be used. The different measured values placed ready by the measurement transmitter are, thus, retrievable via the different fieldbus addresses of the measurement transmitter. This is especially advantageous when the number of measured values placed ready by a measurement transmitter exceeds the number of measured values retrievable by means of a single basic command. This can be the case, for example, when a number of measuring transducers are connected to one measurement transmitter and/or when the measuring transducer provides, besides a primary measured variable, also other measured variables, such as, for example, the temperature of the operating electronics, or measured values derived from the primary measured variable. Thus, for example, the volume flow, the total flow, etc. and other measured values can be determined from the measured flow velocity and be retrievable from the measurement transmitter. For instance, on the one hand, the case can occur that a plurality of measuring transducers are connected to the measurement transmitter, and that the measurement transmitter then processes the measurement signals of these different measuring transducers to measured values and makes them available as described. Moreover, from a (single) measurement signal of a measuring transducer or from a variable derived from the measurement signal, also a number of measured values can be determined and made available by the measurement transmitter.

It can, in such case, suffice to provide a single (communication-)interface and a single communication controller on the measurement transmitter.

In an embodiment of the measurement transmitter, the measured values are retrievable from the measurement transmitter without manufacturer-specific commands (device-specific commands) or general (common practice commands) commands being used. Thus, the use of manufacturer-specific commands or general commands can be completely avoided, and the measured values placed ready by the measurement transmitter only downloaded by application of a basic command, especially a single basic command. Thus, instead of different commands for retrieving different measured values from a measurement transmitter, different fieldbus addresses can be utilized.

In an additional embodiment of the measurement transmitter, the basic command is thus a command, which all devices compatible with the applied fieldbus protocol use. An advantage of this embodiment is that a corresponding programming of the field device for the general commands and the manufacturer-specific commands is absent.

In an additional embodiment of the measurement transmitter, a retrieval of the measured values provided by the measurement transmitter occurs via the fieldbus by means of telegrams, which are addressed to the different fieldbus addresses of the measurement transmitter and include the same basic command. Thus, telegrams, which contain different fieldbus addresses and yet the same command, i.e. same basic command, can be sent via the fieldbus, especially from a so-called master, in order to retrieve the measured values placed ready by the measurement transmitter. If the proposed measurement transmitter connected to the fieldbus determines that one of these fieldbus addresses agrees with one of its fieldbus addresses, then it sends the corresponding measured values associated with the fieldbus address via the fieldbus in the form of a response telegram. Used in this response telegram as originating address can be, for example, the fieldbus address, which was contained in the query telegram and from which the measured values were downloaded from the measurement transmitter.

In an additional embodiment of the measurement transmitter, basic measured values are retrievable from the associated fieldbus address by means of the basic command. Through the basic command, the so-called basic measured values, i.e. the primary, secondary, tertiary and quaternary variables, usual, for example, in the HART protocol, are retrievable. By providing a plurality of fieldbus addresses for a measurement transmitter, the measured values made available by the measurement transmitter can be called by means of the basic command as the basic measured values associated with the fieldbus address and transmitted via the fieldbus.

In an additional embodiment of the measurement transmitter, the logic unit serves, furthermore, to associate the measured values provided by the measurement transmitter with the basic measured values retrievable with the basic command via the different fieldbus addresses of the measurement transmitter. Especially, the logic unit of the measurement transmitter can be used for this.

As regards the method, the object is achieved by features including that the measured values are distributed among the plurality of fieldbus addresses of the measurement transmitter, and that the measured values are retrieved from the measurement transmitter by means of the basic command via the different fieldbus addresses. In this way, as already explained in regard to the proposed measurement transmitter, by means of the basic command, more measured values can be downloaded from the measurement transmitter than by the method known from the state of the art. The measured values made available by the measurement transmitter can for this purpose be retrieved from the measurement transmitter by means different fieldbus addresses. In such case, it can be required correspondingly to program the originator, which requests measured values from the measurement transmitter, and also the measurement transmitter itself.

In an embodiment of the method, no manufacturer-specific or general (so-called common practice) commands are used for retrieving the measured values of the measurement transmitter.

In an additional embodiment of the method, the measured values provided by the measurement transmitter are retrieved via the fieldbus by means of telegrams, which are addressed to the different fieldbus addresses of the measurement transmitter and include a basic command, especially the same, basic command.

In an additional embodiment of the method, the measured values provided by the measurement transmitter are associated with the basic measured values retrievable with the basic command via the different fieldbus addresses of the measurement transmitter.

Furthermore, the object can be achieved by a computer program product with program code means, which program code means are loadable into a memory of a computing unit and, when executed, perform the method of one of the preceding embodiments.

The invention will now be explained in greater detail based on the appended drawing, the figures of which show as follows:

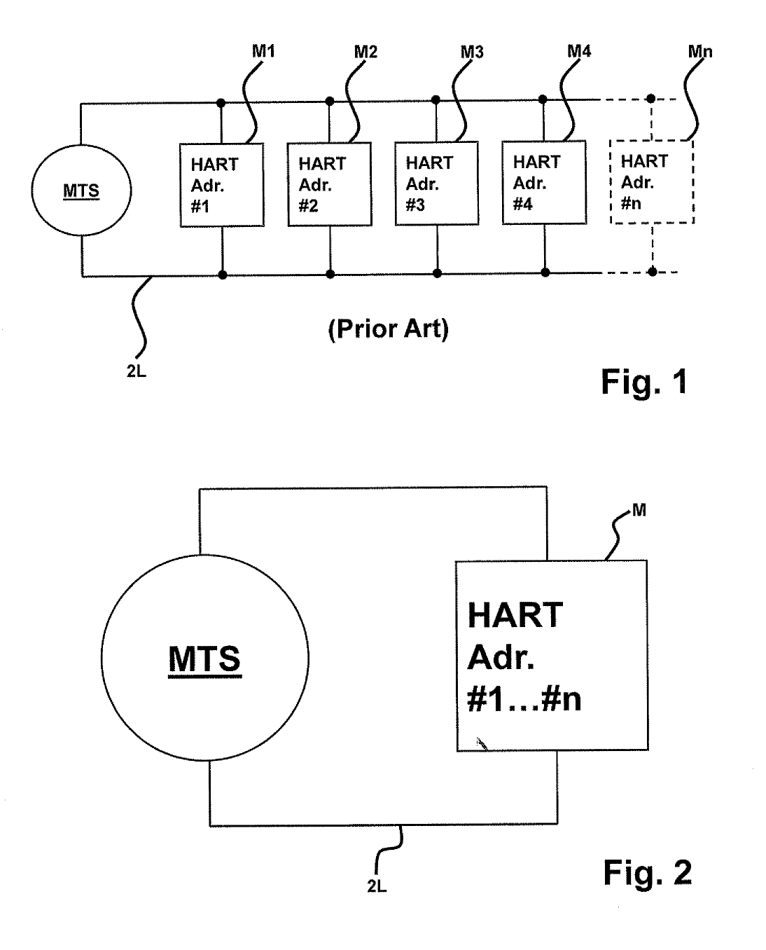

FIG. 1 a schematic representation of an arrangement of field devices from the state of the art,

FIG. 2 a schematic representation of an embodiment of the present invention with a measurement transmitter, which is connected to a two-conductor current loop

FIG. 1 shows a schematic representation of measurement transmitters M1 . . . Mn, which are being operated in the HART multidrop mode. Each of the measurement transmitters M1 . . . Mn has its own fieldbus address #1 . . . #n, via which it is exclusively addressable, i.e. accessible, via the fieldbus. The fieldbus is composed, in such case, essentially of a two-conductor current loop 2L. The two-conductor current loop 2L, to which the measurement transmitters M1 . . . Mn are connected, is supplied with the needed electrical energy by a measurement transmitter power supply device MTS. According to the HART Specification, version 7, up to 15 sensors can be connected in parallel on such a two-conductor current loop 2L and their measured values forwarded digitally via the HART protocol. Thus, it is possible to evaluate the signals of a plurality of sensors.

Since, for the HART-multidrop mode, a number of measurement transmitters are necessary and each measurement transmitter can, according to the standard of the HART protocol, transmit a maximum of four measured values, the number of transmittable measured values is limited. If more than the four measured values should be transmittable from one of the measurement transmitters M1 . . . Mn, special commands, i.e. the above mentioned manufacturer-specific commands, must be introduced. In this way, the measurement transmitters M1 . . . Mn are, however, in given cases, no longer compatible with all HART master devices. Additionally, the measurement transmitter power supply MTS limits the maximum number of measuring transducers, since each measuring transducer also needs energy, in order to be able to perform and/or process measurements.

FIG. 2 shows, schematically, an embodiment of a measurement transmitter M of the invention. Measurement transmitter M has, in such case, a plurality of fieldbus addresses, i.e., in this case, the fieldbus addresses #1 . . . #n. Via these fieldbus addresses #1 . . . #n, the measurement transmitter M is also accessible by other devices (not shown) connected to the fieldbus. The fieldbus is composed in the example of an embodiment according to FIG. 2 also of a two-conductor current loop 2L, which serves, besides for data transmission, also for supplying the measurement transmitter M with energy. The other devices connected to the fieldbus 2L can be, for example, likewise measurement transmitters or, however, also a control unit. Measurement transmitter M can be a so-called slave and the control unit (not shown) a so-called master. The master can, for example, transmit queries in the form of telegrams to a slave via the fieldbus. The slave then answers the query with a response telegram.

For addressing, the fieldbus participants can have fieldbus addresses, for example, according to the example of an embodiment shown in FIG. 1, so that telegrams can be exchanged between the fieldbus participants by means of these addresses.

If a telegram, which is addressed to one of the addresses #1 . . . #n of the measurement transmitter M, is sent via the fieldbus and received by the measurement transmitter M, and the telegram supplementally includes a measured value query by means of a basic command, then the measurement transmitter M sends the measured values associated with such fieldbus address in the form a response telegram back via the fieldbus. Through the use of a plurality of fieldbus addresses #1 . . . #n for a single measurement transmitter M, it is then not necessary to consider the definition, or application, of general command or device-specific commands.

The measurement transmitter M is, in such case, connected via an interface (not shown) to the fieldbus, which, in FIG. 2, is composed of the two-conductor current loop 2L. The interface serves, in such case, for communication via the fieldbus.

Instead of the plurality of measurement transmitters M1 . . . Mn of FIG. 1, thus, corresponding to an embodiment of the present invention, now a single measurement transmitter M, such as is presented in FIG. 2, which has a plurality of fieldbus addresses #1 . . . #n, can be used. This measurement transmitter M possesses, for example, also a plurality of measurement inputs, to which measuring transducers are connectable, and can transmit the measured values won from the corresponding measurement signals via the fieldbus using, for example, the HART protocol. The measurement transmitter M can, thus, simulate a number of measurement transmitters.

The maximum number of measured values transmittable by the measurement transmitter M depends, in such case, just on the possible number of addresses and on the number of measured values transmittable via a (single) telegram of the fieldbus protocol being used. On the fieldbus, measurement transmitter M then appears, for example, as a multidrop network composed of a plurality of measurement transmitters M1 . . . Mn. In this way, the measurement transmitter M is compatible with all multidrop capable masters.

As already mentioned, the number of measuring transducers, which are connectable, for example, to a HART fieldbus, i.e. a fieldbus, which uses the HART-fieldbus protocol, is limited by the available energy, wherein, however, for example, measured variables, such as temperature, pressure and/or flow can also be measured passively and therewith in an energy saving manner. If the measurement transmitter M is connected, for example, to a 4-20 mA, two-conductor, current loop 2L, the measurement transmitter M can provide up to 20 mA from the current loop for measuring.

The proposed invention is especially advantageous with regard to so-called multipoint temperature measurements. In such case, a temperature profile is recorded via measuring transducers, i.e. temperature sensors, distributed in the process. These measuring transducers can now be connected via the proposed measurement transmitter M to an existing fieldbus. The measurement transmitter M can have, for example, a plurality of fieldbus addresses #1 . . . #n, which transmit measured values registered by the connected measuring transducers.

Especially, the measuring transmitter M can have a plurality of analog and/or digital inputs, via which the different measuring transducers are connectable. Also, the measurement transmitter M can measure a plurality of different physical and/or chemical, measured variables. Moreover, the measurement transmitter M can have an on-site display unit, via which the measured values and/or therefrom derived, average, minimum and/or maximum values are displayed. Furthermore, the measurement transmitter M can have a microcontroller, which serves for processing the measurement signals input from the different connectable measuring transducers. Furthermore, also a memory unit for storing the registered, measured values or other process relevant data can be provided in the measurement transmitter.

### LIST OF REFERENCE CHARACTERS

MTS measurement transmitter power supply
2L two-conductor current loop
M measurement transmitter
M1 first measurement transmitter
M2 second measurement transmitter
M3 third measurement transmitter
M4 fourth measurement transmitter
Mn nth measurement transmitter
#1 first fieldbus address
#2 second fieldbus address
#3 third fieldbus address
#4 fourth fieldbus address
#n nth fieldbus address

1-10. (canceled)

11. A measurement transmitter having:
an interface for transmission of measured values via a fieldbus; and
a logic unit, wherein:
communication via the fieldbus occurs according to a fieldbus protocol;
the number of measured values provided by the measurement transmitter exceeds the number of measured values retrievable by means of a basic command of the fieldbus protocol;
the measurement transmitter has a plurality of fieldbus addresses; and
said logic unit serves so to distribute the measured values among the plurality of fieldbus addresses of the measurement transmitter that the measured values are retrievable via the plurality of fieldbus addresses of the measurement transmitter by means of a basic command.

12. The measurement transmitter as claimed in claim 11, wherein:
the measured values are retrievable from the measurement transmitter without manufacturer-specific or general commands being used.

13. The measurement transmitter as claimed in claim 11, wherein:
said basic command is a command, which all devices compatible with the applied fieldbus protocol use.

14. The measurement transmitter as claimed in claim 13, wherein:
a retrieval of the measured values provided by the measurement transmitter occurs via the fieldbus by means of telegrams, which are addressed to the different fieldbus addresses of the measurement transmitter and include said same basic command.

15. The measurement transmitter as claimed in claim 14, wherein:
basic measured values are retrievable from the associated fieldbus address by means of the basic command.

16. The measurement transmitter as claimed in claim 11, wherein:
said logic unit serves, furthermore, to associate the measured values provided by the measurement transmitter with the basic measured values retrievable with the basic command via the different fieldbus addresses of the measurement transmitter.

17. A method for retrieving measured values, provided by a measurement transmitter, which is connected to a fieldbus and has a plurality of fieldbus addresses, wherein communication via the fieldbus occurs according to a fieldbus protocol, and wherein the number of measured values provided by the measurement transmitter exceeds the number of measured values retrievable by means of a basic command of the fieldbus protocol, the method comprises the steps of:
distributing the measured values among the plurality of fieldbus addresses of the measurement transmitter; and
retrieving the measured values from the measurement transmitter by means of the basic command via the different fieldbus addresses.

18. The method as claimed in claim 17, wherein:
no manufacturer-specific or general commands are used for retrieving the measured values of the measurement transmitter (M).

19. The method as claimed in claim 17, wherein:
the measured values provided by the measurement transmitter are retrieved via the fieldbus by means of telegrams, which are addressed to the different fieldbus addresses of the measurement transmitter and include the same basic command.

20. The method as claimed in claim 17, wherein:
the measured values provided by the measurement transmitter are associated with the basic measured values retrievable with the basic command via the different fieldbus addresses of the measurement transmitter.
